(19) United States
(12) Patent Application Publication
(10) Pub. No.: US 2005/0250537 A1
(43) Pub. Date: Nov. 10, 2005

(54) Wireless pay telephone system using multiple subscriber identification module (SIM) cards

(76) Inventor: Jaime Marcelo Narea, Parkland, FL (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/841,658

(22) Filed: May 7, 2004

(51) Int. Cl. H04M 1/00

(52) U.S. Cl. 455/558; 455/406

(57) ABSTRACT

Systems and techniques for providing a telecommunications service by detecting a permanent subscriber identification module (SIM) card and a transitory SIM card in a wireless telephone. The permanent SIM card includes data associated with a primary user of the wireless telephone for connecting to a wireless network. The transitory SIM card includes data associated with a temporary user of the wireless telephone and having a pre-purchased amount of available airtime.

### TECHNICAL FIELD

The present invention relates generally to a wireless communications system and, more particularly, to a wireless pay telephone system using multiple subscriber identification module (SIM) cards.

### BACKGROUND

In many countries to alleviate the need for landline telephone services, local laws allow cellular operators to provide wireless fixed cellular telephone services to consumers. To provide fixed cellular service to consumers, the cellular system must have cellular coverage where the consumer lives, and the consumer must have a fixed cellular telephone. A fixed cellular telephone is similar to a standard landline telephone in most respects but has an antenna that connects to the cellular network instead of a landline connection. In addition, a fixed cellular telephone also requires a subscriber identification card (SIM) card for connection to the cellular network and for operation. In general, the SIM card includes a memory storage device (e.g., embedded chip) containing the telephone number and other important information associated with the end user.

The Global System for Mobile Communications (GSM) system and some Code Division Multiple Access (CDMA) cellular systems also require the use of SIM cards for connection and for proper operation. Some GSM cellular operators have used a pre-payment method that involves selling the end user a SIM card with a telephone number and purchased airtime. The end user places the SIM card in a slot in the telephone enabling the telephone to place and receive telephone calls. When the airtime has been consumed, the end user can purchase additional airtime by going to a point of sale and buying more airtime minutes for the SIM card.

Pre-payment methods are especially popular in countries were post payment collection has a high cost or is not practical. Accordingly, as GSM and CDMA systems continue to expand and pre-payment continues to be a popular choice for payment of airtime minutes, new methods for pre payment are needed.

### SUMMARY

In one general aspect, systems and techniques for providing a telecommunications service include detecting a permanent subscriber identification module (SIM) card and a transitory SIM card in a wireless telephone. The permanent SIM card includes data associated with a primary user of the wireless telephone for connecting to a wireless network. The transitory SIM card includes data associated with a temporary user of the wireless telephone and having a pre-purchased amount of available airtime.

Aspects of the present invention may be implemented by an apparatus and/or by a computer program stored on a computer readable medium. The computer readable medium may comprise a disk, a client device, a network device, and/or a propagated signal.

Other features and advantages will be apparent from the following description, including the drawings, and from the claims.

### DESCRIPTION OF THE DRAWINGS

FIG. 1 is a block diagram illustrating aspects of a wireless communications system.

FIG. 2 is a block diagram expansion of aspects of FIG. 1.

FIG. 3 is a flow chart of a communications method that may be implemented by the wireless communications system illustrated in FIGS. 1 and 2.

### DETAILED DESCRIPTION

According to aspects of the present invention, telecommunications services are provided to a wireless telephone having multiple SIM cards. It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be provided in various implementations.

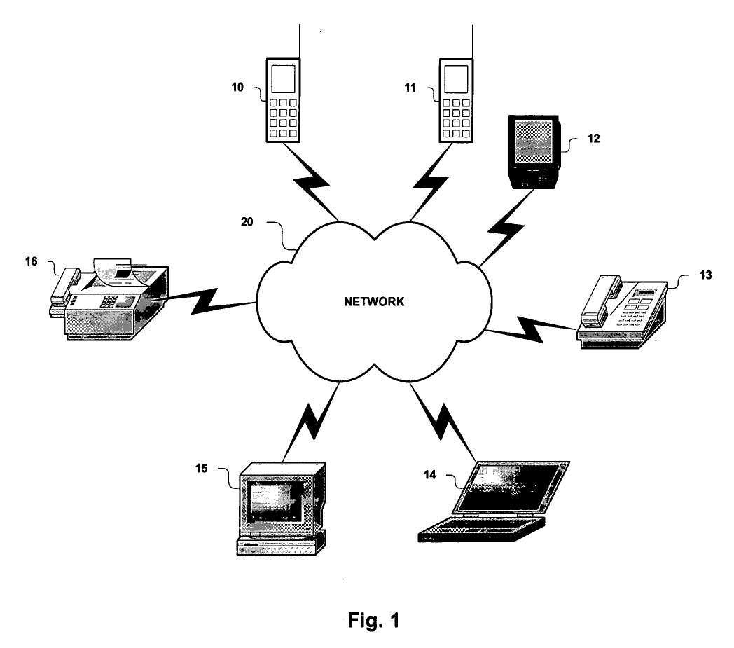

FIG. 1 illustrates an exemplary communications system including a wireless telephone 10 connected through a wireless network 20 to one or more various devices including, for example, another wireless telephone 11, a personal digital assistant (PDA) 12, a laptop personal computer (PC) 13, a desktop PC 14, and a facsimile machine 15. In general, the devices include hardware and/or software components for communicating with the wireless network 20 and are structured and arranged to communicate using various communication protocols for establishing connections between network elements and other devices and/or for operating within or in concert with one or more other systems (e.g., the Internet and/or Web). The devices may include one or more computer programs for establishing and performing communications functions. The computer programs may be embodied permanently or temporarily in any type of machine, component, physical or virtual equipment, storage medium, or propagated signal capable of providing instructions to the wireless device. In particular, the computer programs may be stored on a storage medium or device (e.g., EEPROM, magnetic diskette, or propagated signal) readable by a computer system, such that when the storage medium or device is read by the computer system, the functions described herein are performed.

The wireless network 20 may directly or indirectly connect the wireless telephone 10 to the other devices 11-15. In one implementation, the wireless network 20 is a is GSM wireless network or a CDMA wireless network

In addition to telephone services, the wireless network 20 may provide telecommunications services such as, for example, telephone services, messaging services, information services, paging services, voicemail services, facsimile services, interactive voice response (IVR) services, and text-to-speech services. The wireless network 20 also may include an information delivery network supporting a variety of telecommunications and/or data services including Internet and/or web access, e-mail and/or instant messaging services, paging services, audio and/or video streaming, and/or directory services.

Examples of networks include, but are not limited to, a local area network (LAN), a wide area network (WAN), a telephone network (e.g., analog, digital, wired, wireless, PSTN, ISDN, or XDSL), a radio network, a television network, a cable network, a satellite network, and/or any other communications network configured to carry data. Each network may include one or more elements, such as, for example, intermediate nodes, proxy servers, routers, switches, adapters, and wired or wireless data pathways, configured to direct and/or deliver data.

Aspects of the wireless network 20 may include a bi-directional wireless data service capable of connecting to other complimentary networks. The wireless data service may include a hierarchy of communications systems that can provide wireless service through a network of base stations and local switches under the control of higher order regional switches or exchanges.

In one implementation, the wireless network 20 includes base stations (not shown) for connecting to wireless devices. In general, the base stations function as interfaces between wireless devices and the wireless network 20. The base stations may include transmitters, receivers, and switching devices for providing cellular telephone services and for performing switching functions to permit communication between devices. The base stations also may perform various communications functions such as user identification, subscription verification, location detection, mobile tracking, call processing, call routing, and/or other signaling functions necessary to control calls to and from other telecommunications and data systems. The base stations may perform protocol conversions necessary to enable communications through complimentary networks such as, for example the Internet, the World Wide Web, and/or other telecommunications networks that provides information. For example, the base stations may carry out protocol conversion between a mobile communications protocol and an Internet communication protocol.

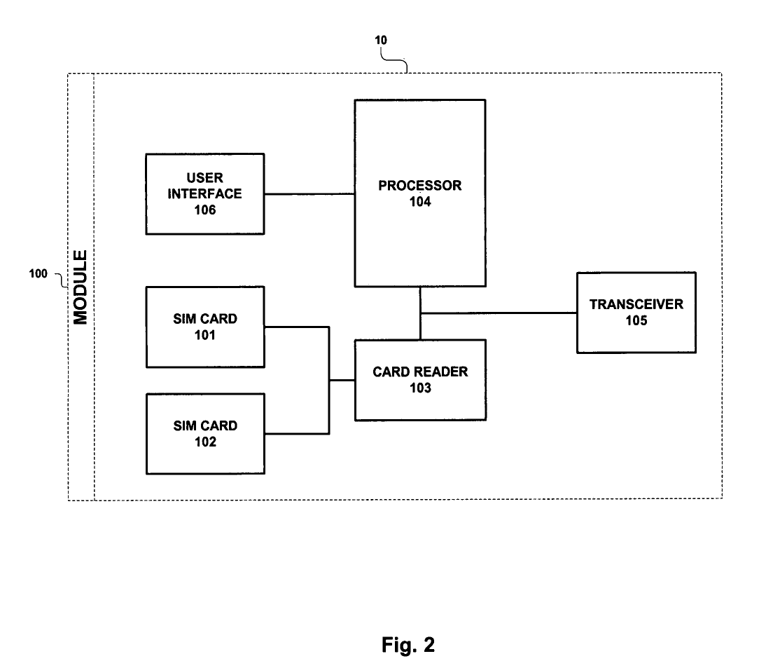

FIG. 2 illustrates an exemplary wireless telephone 10 according to one embodiment of the present invention. As shown, the wireless telephone 10 includes a control module 100 for controlling the functionality of the wireless telephone 10. In FIG. 2, the broken lines are intended to illustrate that the control module 100 may control one, some, or all of the elements of the wireless telephone 10.

One example of a control module 100 is a program on the wireless telephone 10 that commands and directs operations and communications. Other examples include a software application, a piece of code, an instruction, another device, or some combination thereof. The control module may be implemented as computer code utilizing any suitable computing language (e.g., Java, C or C++). The control module also may be a computer, such as a workstation or PC, a microprocessor, a network server, a Java virtual machine, or an application specific integrated circuit, using any suitable type of computer instructions.

The control module 100 may be embodied permanently or temporarily in any type of machine, component, physical or virtual equipment, storage medium, or propagated signal capable of providing instructions to a device. In particular, the control module (e.g., software application, computer program) may be stored on a storage media or device (e.g., ROM, magnetic diskette, or propagated signal) readable by a general or special purpose computer system, such that if the storage media or device is read by the computer system, the functions described herein are performed.

In one embodiment, the wireless telephone 10 is a fixed cellular telephone including a first SIM card 101 and a second SIM card 102. In this embodiment, the first SIM card 101 functions generally as a permanent SIM card associated with the owner of the wireless telephone 10. The second SIM card 102 functions generally as a transitory SIM card associated with a temporary user of the wireless telephone 10. In some embodiments, the first SIM card 101 is small, i.e. chip size, and the second SIM card 102 is approximately the size of a credit card.

In one implementation, the first SIM card 101 is placed in the wireless telephone 10 at all times for standard operation, and the second SIM card 102 is placed in the wireless telephone 10 at various time for pay telephone operation. In most cases, the second SIM card 102 will include prepaid airtime. In general, the first SIM card 101 will be activated by the owner of the wireless telephone 10, and the second SIM card 102 will be activated by another person such as a customer of the owner, for example. The owner can thus use the wireless telephone 10 through the first SIM card 101 and can permit or encourage use by another person who inserts a second SIM card 102.

As shown, the wireless telephone 10 includes a card reader 103 for reading the first SIM card 101 and the second SIM card 102. In general, the card reader 103 may be structured and arranged to recognize and distinguish the first SIM card 101 and the second SIM card 102. In one embodiment, a single card reader 103 is associated with multiple SIM card slots. In another embodiments, the wireless telephone 10 may include more than one card reader 103.

The wireless telephone also includes a processor 104 and a transceiver 105. In general, the processor 104 may include logic for conducting a telephone call in accordance with data contained in the first (permanent) SIM card 101 and/or the second (transitory) SIM card 102 and signals received by the transceiver 105. In one implementation, the transceiver 105 may be structured and arranged to transmit and receive radio frequency (RF) signals to and from a base station of a wireless network operator. The RF signals may include voice and/or data signals and, in some cases, may undergo conversion, demodulation, and/or other processing prior to transmission or after receipt.

In one embodiment, the transceiver 105 receives RF signals from a local base station when the wireless telephone 10 is within a coverage area. In response, the transceiver 105 provides the base station with information contained on the first SIM card 01 and/or the second SIM card 102, as determined by the processor 104.

In one implementation, the processor 104 directs the transceiver 105 to transmit data from the first SIM card 101 whenever the card reader 103 reports that the wireless telephone 10 only includes the first SIM card 101, i.e., a second SIM card 102 is not present. The processor directs the transceiver 105 to transmit data from the second SIM card 102 whenever the card reader 103 reports the presence of the second SIM card 102. In some implementation, the processor 104 directs the transceiver 105 to transmit data from the second SIM card 102 until the pre-paid airtime is consumed and then to transmit data from nthe first SIM card 101 until a call is completed. In other implementations, the processor 104 directs the transceiver 105 to transmit data from both the first SIM card 101 and the second SIM card 102 so that the owner of the wireless telephone 10 can share in the revenue to the operator for connecting the telephone call.

The wireless telephone 10 includes a user interface 106. In general, the user interface 106 displays information to the owner of the wireless telephone 10 and/or a caller. In one implementation, the user interface 106 displays the airtime balance for the first SIM card 101 and/or the second SIM card 102. In some cases, the user interface 106 may prompt the user to select the first SIM card 101 or the second SIM card 102 and/or to enter a code for activating the first SIM card 101 or the second SIM card 102.

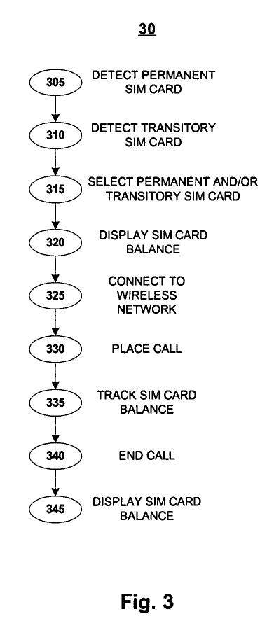

Referring to FIG. 3, a communications system operates according to a procedure 300 for providing wireless pay telephone service. The procedure 300 may be implemented by any suitable type of hardware (e.g., device, computer, computer system, equipment, component); software (e.g., program, application, instructions, code); storage medium (e.g., disk, external memory, internal memory, propagated signal); or combination thereof.

In one implementation, the procedure 30 provides a wireless pay telephone service by detecting a permanent SIM card (step 305), detecting a transitory SIM card (step 310), selecting the permanent and/or transitory SIM card (step 315), displaying a SIM card balance (step 320), connecting to a wireless network (step 325), placing a call (step 330), tracking SIM card balance (step 335), ending the call (step 340), and displaying the SIM card balance (step 345).

At step 305, the permanent SIM card is detected. In general, the permanent SIM card is required for operation of the wireless telephone 10 and is always present within the wireless telephone 10. In one implementation, the wireless telephone 10 performs an authorization procedure by recognizing that the permanent SIM card is valid and detecting the user information.

At step 310, the transitory SIM card is detected. In one implementation, a temporary user inserts a transitory SIM card into the wireless telephone 10. In one implementation, the wireless telephone 10 performs an authorization procedure by recognizing that the transitory SIM card is valid and detecting the user information.

At step 315, the permanent and/or the transitory SIM card is selected. In one implementation, the wireless telephone 10 is designed to select the transitory SIM card 102 if present in the card reader 103 of the wireless telephone 10. Otherwise, the permanent SIM card 101 associated with the primary user is selected.

At step 320, a SIM card balance is displayed. In one implementation, the wireless telephone 10 includes a user interface 106 that displays the amount of minutes available through the transitory SIM card 102.

If the card displays the no airtime is available or if there is not enough available airtime to complete a desired call, the user may purchase more airtime or retrieve the transitory SIM card. In one implementation, a user can purchase airtime by paying the owner of the wireless telephone 10. The owner may enter a code into the wireless telephone 10 and is instructed to enter airtime in minutes or (local) currency amount. After the owner enter the amount of airtime requested by user, the wireless telephone 10 prompts the owner for confirmation. If the amount is confirmed, the transitory SIM card 102 is loaded with the requested minutes or currency amount, and the wireless telephone 10 displays the new airtime SIM card balance.

At step 325, a connection to the network is established. In general, the wireless telephone 10 may receive telecommunications services if the wireless telephone is physically located in an area serviced by the wireless network 20.

At step 330, a call is placed. After the wireless telephone 10 is connected, the wireless network 20 may transmit a menu of available telecommunications services. The wireless telephone 10 may display the menu on a user interface 106. By interacting with the user interface 106, a user may select a telecommunication service from the menu. Interacting with the user interface 106 may involve providing user input by scrolling through pages, selecting various icons, and/or entering text.

In general, a user can place a call if the SIM card 102 has airtime available. The wireless telephone 10 instructs the user to begin the dial up process through the user interface 106, for example. The user dials the number and starts the call process. If the call does not go through because the system is busy or the called party does not answer, no airtime is taken from the SIM card 102. The wireless telephone 10 may include an alarm activated after a period of time (e.g., 15 seconds) to remind the user to retrieve the SIM card 102.

At step 335, the SIM card balance is tracked. When a call is successfully placed, a base station through which the call is placed maintains the actual balance for the SIM card 102. The base station may track the dialed number, the duration of the call, the charge for the call, and the remaining airtime until the call is completed. In one implementation, the wireless telephone may alert the user if the remaining airtime falls below a threshold amount. In some implementations, a balance for the permanent SIM card 101 also may be tracked. For example, the base station or wireless network 20 may keep an account for the owner of the wireless telephone 10 indicating the number of pay calls placed and the amount of pay airtime used in a given month, so that revenues can be shared between the operator and the owner of the telephone 10. Tracking data that associates the owner with temporary SIM card use provides an incentive for owners to implement a wireless pay telephone system.

At step 340, the call ends. In general, the call terminates when the user hangs up. The call also may end if the user retrieves the transitory SIM card 102 from the telephone 10 during a call.

At step 345, the SIM card balance is displayed. In one implementation, the wireless telephone 10 includes a user interface 106 that displays the airtime balance for the transitory SIM card 102. In some implementations, the wireless telephone 10 may display a balance associated with the permanent SIM card 101 so that the owner can track revenue that has been generated. The owner of the wireless telephone owner can share the revenue of the telephone call with the cellular operators.

As described above, the wireless telephone 10 has the ability to accept two SIM cards, i.e. a permanent SIM card 101 and a transitory SIM card 102. As a result, the owner of the wireless telephone 10 has the ability to create a pay telephone business. In some implementations, the owner and wireless telephone 10 will be associated with a business such as a store, shop, salon, market, restaurant, taxi, mass transportation vehicle (e.g., bus, train, subway), etc. As such, the wireless pay telephone system can be a secondary source of income for the business. In other implementations, the wireless pay telephone may be used from the home of an owner thus providing a residential pay telephone business.

Because most pay telephone businesses are done using very expensive set ups with heavy-duty materials, cellular telephone system operators have not been able to efficiently provide pay telephone services in shops, restaurants, mass transportation vehicles, etc. According, wireless operators will have an incentive to use the wireless pay telephone system described above. In addition, people that typically do not have access to telephone services can access telephone services using only a prepaid card in places where an owner makes a wireless telephone available. A person conveniently slides the prepaid SIM card into wireless telephone, makes a telephone call, and retrieves the card for future calls.

The examples presented herein are intended to illustrate potential implementations of the present method and system embodiments. It can be appreciated that such examples are intended primarily for purposes of illustration. No particular aspect or aspects of the example method and system embodiments described herein are intended to limit the scope of the present invention.

It also can be appreciated that, in some embodiments of the present methods and systems disclosed herein, a single component can be replaced by multiple components, and multiple components replaced by a single component, to perform a given function. Except where such substitution would not be operative to practice the present methods and systems, such substitution is within the scope of the present invention.

A number of embodiments and implementations have been described. Nevertheless, it will be understood that various modifications may be made and that other embodiments and implementations are within the scope of the following claims.

1. A communications method comprising:
detecting a permanent subscriber identification module (SIM) card in a wireless telephone, the permanent SIM card including data associated with a primary user of the wireless telephone for connecting to a wireless network; and
detecting a transitory SIM card in the wireless telephone, the transitory SIM card including data associated with a temporary user of the wireless telephone and having a pre-purchased amount of available airtime.

2. The communications method of claim 1, further comprising connecting to the wireless network using at least one of the permanent SIM card and the transitory SIM card.

3. The communications method of claim 2, wherein the transitory SIM is used to connect to the wireless network.

4. The communications method of claim 2, wherein the permanent SIM card and the transitory SIM are used to connect to the wireless network.

5. The communications method of claim 4, wherein the permanent SIM is used to connect to the wireless network after the amount of available airtime is consumed.

6. The communications method of claim 1 wherein the wireless network is at least one of a Global System for Mobile Communications (GSM) system and a Code Division Multiple Access (CDMA) cellular system.

7. The communications method of claim 1, further comprising displaying a balance associated with the transitory SIM card.

8. The communications method of claim 1, further comprising displaying a balance associated with the permanent SIM card.

9. The communications method of claim 8, wherein the balance associated with the permanent SIM card tracks generated revenue.

10. The communications method of claim 1, further comprising adding airtime to the transitory SIM card.

11. A communications apparatus comprising:
at least one card reader structured and arranged to read a permanent subscriber identification module (SIM) card and a transitory SIM card when inserted into a wireless telephone, the permanent SIM card including data associated with a primary user of the wireless telephone for connecting to a wireless network, and the transitory SIM card including data associated with a temporary user of the wireless telephone and having a pre-purchased amount of available airtime.

12. The apparatus of claim 11, further comprising a permanent SIM card.

13. The apparatus of claim 12, wherein the permanent SIM card is chip size.

14. The apparatus of claim 11, further comprising a transitory SIM card.

15. The apparatus of claim 14, wherein the transitory SIM card is credit card size.

16. The apparatus of claim 11, further comprising a transceiver for transmitting and receiving radio frequency signals.

17. The apparatus of claim 11, further comprising a processor for selecting the permanent SIM card or the transitory SIM card.

18. The apparatus of claim 11, further comprising a user interface for displaying information regarding at least one of the permanent SIM card and the transitory SIM card.

19. A computer program stored on a computer-readable medium, the computer program comprising instructions to:
detect a permanent subscriber identification module (SIM) card in a wireless telephone, the permanent SIM card including data associated with a primary user of the wireless telephone for connecting to a wireless network; and
detect a transitory SIM card in the wireless telephone, the transitory SIM card including data associated with a temporary user of the wireless telephone and having a pre-purchased amount of available airtime.

20. The computer program of claim 19, wherein the computer-readable medium comprises at least one of a disk, a client device, a network device, and a propagated signal.
